(19) United States
(12) Patent Application Publication
(10) Pub. No.: US 2009/0182118 A1
(43) Pub. Date: Jul. 16, 2009

(54) METHOD FOR PRODUCING POLYGUANIDINES

(75) Inventors: Juriy Vasyliovych NYZHNYK, Kiev (UA); Ganna Ivanivna BARANOVA, Kiev (UA); Viktor Fedorovych MARIEVSKYI, Kiev (UA); Lyudmyla Mykolaivna FEDOROVA, Kiev (UA); Oksana Mykolaivna NADTOKA, Kiev (UA); Taras Jurievich NYZHNYK, Kiev (UA)

Correspondence Address: HOUSTON ELISEEVA, 4 MILITIA DRIVE, SUITE 4, LEXINGTON, MA, 02421, US

(73) Assignee: CLOSED JOINT-STOCK COMPANY "SCIENTIFIC AND TECHNOLOGICAL CENTER 'UKRVODBEZPEK, Kiev (UA)

(21) Appl. No.: 12/413,720

(22) Filed: Mar. 30, 2009

Related U.S. Application Data
(63) Continuation of application No. PCT/UA2007/000059, filed on Sep. 25, 2007.

(30) Foreign Application Priority Data
Sep. 29, 2006 (UA) A200610366

(51) Int. Cl. C08G 73/00

(52) U.S. Cl. 528/422

(57) ABSTRACT

The invention relates to polyguanidine synthesis. The inventive method for producing polyguanidines consists in polycondensing a guanidine salt with diamine during heating in the presence of an organic acid or a mixture of organic acids. A heating process is carried out stepped process and consists in gradually increasing a temperature up to 120-130° C. and in holding at said temperature for 0.5-1.0 hour, in increasing a temperature up to 150-160° C. and in holding at said temperature for 3.5-4.0 hours and in increasing a temperature up to 170-180° C. and in holding at said temperature for 1.0-1.5 hours. Said method makes it possible obtain, in a more full manner and in shorter time, a polyguanidine, which exhibits a high biological activity. The thus obtained polyguanidines are not toxic and can be efficiently used for treating drinking and sewage waters and for producing antiseptic, cosmetic and disinfecting agents.

### RELATED APPLICATIONS

This application is a Continuation of International application Number PCT/UA2007/000059, filed on Sep. 25, 2007, which claims priority to Ukrainian Patent Application No. a200610366, filed on Sep. 29, 2006, both of which are incorporated herein by reference in their entirety.

### FIELD OF THE INVENTION

The present invention refers to polymer organic chemistry and namely synthesis of polyguanidines and can be used in health care, veterinary, cosmetology, drinking water and sewage treatment.

### BACKGROUND OF THE INVENTION

The issue of infectious microorganism control, biodestruction of materials and biofouling of equipment operating in water is vital regardless of considerable choice of biocidal products.

The vast majority of disinfecting means contain toxic substances or create toxic destruction products. Toxicity and aggressiveness of traditional chlorine-based preparations, aldehyde and phenol preparations pose risk to human health and environment and necessitate the development of environmentally safe and low-toxic agents.

Since recently considerable attention has been paid to disinfectants on the basis of polyguanides with high biocidal characteristics, low toxicity and stable structures.

The method is known for producing of polyguanides by polycondensation of guanidine salt with amines taken in equimolar proportions at heating with production of polyguanidine, polyguanidine rectification at polycondensation stage by repeated precipitation or exchange of anions using layer separation, drying and cooling operation (Patent, RU 2172748 C2, IPC C08O 73/00, A61L 2/16, published on 27 Aug. 2001) [1]. Cooling is performed by separation of polyguanidine melt into discrete jets in air flow with further granulation. During condensation diamines or their mixtures with diaminoaethers or higher amines are used and heated under the following conditions: gradual heating up to the temperature of 120° C., aging at this temperature for 3 hours, increase of temperature and ageing at 150° C. for 5 hours, further increase of temperature and aging at 180° C. for one hour.

The known method for producing of polyguanidines is not adaptable to streamlined production, requires polyguanidine rectification stage by way of repeated precipitation which leads to formation of large quantities of sewage water. Biocidal activity of the polyguanidine is not sufficiently high.

Known is the method for producing of polyguanidines that involves interaction of hexamethylendiamine and melt of guanidinehydrochloride when heated (SU, 1616898, IPC C07C 279/00, A61L 2/16, published on 30 Dec. 1990) [2]. At the same time, the hexamethylendiamine melt at the temperature of 50° C. is gradually introduced into the guanidinehydrochloride melt heated to the temperature of 180° C., the proportion of hexamethylendiamine and guanidinehydrochloride being 1:(0.85-0.95) respectively. Hexamethylendiamine is being added for 2.5 hours under the stable temperature of 180° C. After that the temperature should be increased to 240° C. and maintained on this level for the period of 5 hours.

The suggested method is rather energy-consuming while polyguanidine so produced contains considerable quantities of initial monomers which makes it more toxic and unsuitable for use in drinking water treatment, as well as medicine and pharmaceutical industry.

The closest prior art is the method of a disinfectant production by means of polycondensation of guanidine salt with diamine at heating and production of raw salt (Patent, RU 2052453 C1, IPC C07C 279/02, published on 20 Jan. 1996) [3]. Hexametilendiamine is used as diamine and the substances during polycondensation are heated in accordance with the following pattern: Hexametilendiamine is quickly added to the guanidine salt melt with temperature of approx. 180-200° C., the condensation mixture is in holding at the temperature of 180-200° C. and stirred till completion of ammonium evolution (10-15 hours). Further water is added to the raw polyhexamethylendiamine salt in order to achieve a 10-40% concentration, after that the equimolar amount of acid or its salt is introduced, or (if needed) 1.0-1.2 mole of alkaline is added to the 10-40% water solution, the hardly soluble basis of polyhexamethylendiamine being separated and rinsed 1 to 3 times in the quantity equal to or lesser than that of polyhexamethylendiamine at the temperature of 20 to 80° C. and after the separation of water an equimolar quantity of acid or its salt is introduced. For this purpose a non-organic acid or water soluble organic acid is used.

The disadvantage of the known method is a low biological activity of the obtained polyguanidine caused by present residues of non-organic components and unreacted initial monomer as well as the formation of partially cross-linked product. As a result of polycondensation, a raw salt is obtained that is further processed and rectified complicating therewith the production method and sewage formation.

### SUMMARY OF THE INVENTION

The purpose of the invention is to improve the method for producing polyguanidines wherein on the basis of polycondensation of guanidines with diamines in the presence of certain substance at certain temperature conditions polyguanidines with higher biological activity are obtained during a shorter period of time and with better yield. The obtained polymer product is a high molecular polyguanidine, non-toxic, with slight quantities of residual monomer. The method is adaptable to streamlined production and allows getting the final product in just one stage without waste water formation. The properties of the obtained polyguanidine are stable and enable to effectively use it for purification of drinking and waste waters, preparation of disinfectants, antiseptic agents and cosmetics.

The objective is attained through the suggested method for producing polyguanidine by means of polycondensation of guanidine salt with diamine being heated when polycondensation is performed in the presence of organic acid or mixture of organic acids with stepped heating in the regime that involves gradual increase of temperature to 120-130° C. and in holding at said temperature for 0.5-1 hour, then the increase of temperature to 150-160° C. and in holding at said temperature for 3.5-4 hours, further increase of temperature to 170-180° C. and in holding at said temperature for 1-1.5 hour. Alkylenediamine or oxyalkylendiamine of general formula (I) are used as diamine:

NH₂—R₁—NH₂, (I)

where R₁ is selected from C₂-C₁₀alkyl, —(CH2)ₚ—O—(CH₂)_{q}—O⁻(CH)ᵣ, —(CH₂)ₚ—O—(CH₂)_{q}—O—(CH)ᵣ—O—(CH)₅— where p, q, q are selected from 2 to 6. Particularly, hexamethylenediamine, octamethylenediamine, dioxadodecane-1,12-diamine, trioxamidecane-1,13-diamine, 3,6-diamine-1,8-diaminooctane are used as diamine.

Guanidine salt is selected from the range including guanidine chloride, guanidine sulphate, guanidine carbonate or guanidine nitrate.

In the suggested the method organic acid that is present at polycondensation reaction or mixture of acids are selected from the series:

monocarboxylic acids of the general formula:

R₁—COOH, (II)

where R₁ is selected from —C₉-C₁₈alkyl, —C₉-C₁₈alkenyl, —C₆H₅, —C₅H₄N, —C₅H₄CH₃, —C₅H₄NH₂, —C₅H₄OH, —C₅H₄OCOCH₂, or

dicarboxylic acids of the general formula:

HOOC—R₂—COOH, (III)

where R₂ is selected from —(CH₂)ₙ, n=0-8, —CₙH₂ₙ₋₁NH₂, n=1-4, —(CHOH)ₙ, n=1-4, —(CₙH₂ₙ₋₂), n=2-6, —C₆H₅, or

tricarboxylic acids of general formula:

R₃(COOH)₃, (IV)

where R₃ is selected from —CₙH₂ₙ₋₁₋ₘ(OH)ₘ, n=3-5, m=0-1.

The following compounds are used as organic acids:

Saturated monocarboxylic fatty acids such as decane, methane-, ethane-, propane-, butane-, pentane-, hexane-, heptane-, octane-, nonandecane;

Unsaturated monocarboxylic fatty acids such as decene, methane-, ethane-, propane-, butane-, pentane-, hexane-, heptane-, octane-, nonandecene;

monocarboxylic aromatic acids such as benzoic, (ortho-, meta-, para-)toluoylic, (ortho-, meta-, para-)aminebenzoic, (ortho-, meta-, para-)hydroxybenzoic (ortho-, meta-, para-) acetylhydroxibenzoic, pyridincarboxylic;

saturated dicarboxylic fatty acids such as ethane-, propane-, butane-, pentane-, hexane-, heptane-, octane-, nonane-, decane-, α-aminopropane, α-aminobutane, α-aminopentane, α-aminohexane diacids;

oxydicarboxylic acids such as oxypropane-, α,β-dioxybutane-, α,β,γ-trioxypentane-,α,β,γ,ω-tetraoxyhexane diacids;

unsaturated dicarboxylic acids such as butane-, pentene-, hexen-, heptene-, octane diacids;

dicarboxylic acids of aromatic series such as 1,2-benzene dicarboxylic, 1,3-benzene dicarboxylic, 1,4-benzene dicarboxylic acids;

tricarboxylic acids such as 2-oxy-1,2,3-propanetricarboxylic, 3-oxy-1,3,5-pentanetricarboxylic acids.

In the proposed method an organic acid or mixture of organic acids are added to the mixture prior to polycondensation and/or during the first stage of heating in the amount of 0.01-16 weight % of the reaction mixture, preferably 0.05-1.0 weight %.

In the process of investigation we have been unexpected found that the polycondensation of guanidine salt with diamine in the presence of some organic acids under certain temperature conditions allows to increase the bioactivity of the obtained polyguanidine through a more complete and dynamic catalyzed process of polyguanidine polycondensation. The final product of polycondensation is a mixture of polyhomologues similar by molecular weight, which does not contain primary substances or require any further purification.

The above and other features of the invention including various novel details of construction and combinations of parts, and other advantages, will now be more particularly described and pointed out in the claims. It will be understood that the particular method and device embodying the invention are shown by way of illustration and not as a limitation of the invention. The principles and features of this invention may be employed in various and numerous embodiments without departing from the scope of the invention.

### DETAILED DESCRIPTION OF THE PREFERRED EMBODIMENTS

The method is implemented as follows.

Guanidine salt and diamine in molar proportion of (0.75−1)÷1 are placed into a flask which contains a stirrer, thermometer and reflux condenser. An organic acid or mixture of organic acids in the amount of 0.01-16 weight % of the reaction mixture, preferably 0.05-1.0 weight %, are added to the mixture with stepped heating stage: the temperature is gradually increased to 120-130° C. at the first step and the mixture is in holding at 120-130° C. for one hour, further the temperature is increased to 150-160° C. and the mixture is in holding at this temperature for 3.5-4 hours and finally, the mixture is heated up to 170-180° C. and in holding at this temperature for 1-1.5 hours. Organic acid or mixture of organic acids are added before the heating and/or at the first stage of heating i.e. when increasing the temperature or in holding the reaction mixture at 120-130° C.

Suitable diamines are alkylen diamines or oxyalkylen diamines with general formula: NH₂—R₁—NH₂, where R₁ is selected from the group consisting —C₂-C₁₀alkylen, —(CH₂)ₚ—O—(CH₂)_{q}—O—(CH)ᵣ, —(CH₂)ₚ—O—(CH₂)_{q}—O—(CH)ᵣ—O—(CH)₃ with p, q r, ranging from 2 to 6, or their mixture. For instance, hexamethylendiamine, octamethylendiamine, dioxadodecane-1,12-diamine, trioxatrudecane-1,13-diamine, 3,6-diamin-1,8-diamineoctane. Suitable guanidine salts are guanidine chloride, sulphate, carbonate or nitrate.

The following agents are used as an organic acid:

monocarboxylic acids of general formula R₁—COOH, where R₁ is selected from —C₉-C₁₈alkylene, —C₉-C₁₈alkenyl, —C₆H₅, —C₆H₄N₁, —C₅H₄CH₃, —C₅H₄NH₂, —C₅H₄OH, —C₅H₄OCOCH₂, included but not limited decane acid, methanedecane acid, ethanedecane acid, propanedecane acid, butanedecane acid, pentanedecane acid, hexanedecane acid, heptanedecane acid, octanedecane acid, nonanedecane acid, decene acid, methanedecen acid, ethanedecen acid, propanedecen acid, butanedecen acid, pentanedecen acid, hexanedecen acid, heptanedecen acid, octanedecen acid, nonanedecen acid, benzoic acid, (ortho-, meta-, para-)toluoylic acid, (ortho-, meta-, para-)aminebenzoic acid, (ortho-, meta-, para-)hydroxybenzoic acid, (ortho-, meta-, para-)acetylhydroxibenzoic acid, pyridincarboxylic acid or mixture thereof,

dicarboxylic acids of the general formula HOOC—R₂—COOH, where R₂ is selected from —(CH₂)ₙ, n=0-8, -CnH₂ₙ₋₁NH₂, n=1-4, —(CHOH)ₙ, n=1-4, —(CₙH₂ₙ₋₂), n=2-6, —C₆H₆, included but not limited ethane diacid, propane diacid, butane diacid, pentane diacid, hexane diacid, heptane diacid, octane diacid, nonane diacid, decane diacid, α-aminopropane diacid, α-aminobutane diacid, α-aminopentane diacid, α-aminohexane diacid, α-aminopropane diacid, α-aminobutane diacid, α-aminopentane diacid, α-aminohexane diacid, α,β-dioxybutane diacid, α,β,γ-trioxypentane diacid, α,β,γ,ω-tetraoxyhexane diacid, butene diacid, pentene diacid, hexen diacid, heptene diacid, octene diacid, 1,2-benzene dicarboxylic, 1,3-benzene dicarboxylic, 1,4-benzene dicarboxylic acid or mixture thereof,

tricarboxylic acids of the general formula R₃(COOH)₃, where R₃—CₙH₂ₙ₋₁₋ₘ(OH)ₘ, n=3-5, m=0-1, included but not limited 2-oxy-1,2,3-propanetricarboxylic acid, 3-oxy-1,3,5-pentanetricarboxylic acid or mixture thereof.

### EXAMPLES

Below are given the examples describing however not limiting the invention.

Guanidinehydrochloride and hexamethylendiamine in 1:1 molar ratio are introduced into a three-necked flask that contains a stirrer, thermometer and reflux condenser.

To the reaction mixture is added citric acid (2-oxi-1,2,3-propanetricarboxylic acid) in the mass amount of 0.23 weight % of the reaction mixture (Table 1). The reaction mixture is further heated on oil bath: the temperature is being gradually increased up to 125° C. and in holding at said temperature for 1 hour, further the reaction mixture is heated to 160° C. and in holding at said temperature for 3.5 hours, after that the mixture is heated up to 180° C. and in holding at said temperature for 1.5 hours.

As a result a polymer product is obtained in the form of a transparent glasslike yellow-green substance, which is a high molecular polyguanidine with viscosity of 0.14 dL/g, residual monomer concentration equaling 0.19 weight %. Total synthesis time is 6 hours.

The bioactivity of the obtained polyguanidine was assessed via the double dilution technique on test cultures of Staf. Aureus and Candida Albicans. The research findings of the obtained polyguanidine features are shown in Table 2.

Similarly, other examples of polyguanidine production method were implemented. The information about primary components and polycondensation conditions is presented in the Table 1, whereas the findings of examination of the produced polyguanidines are presented in the Table 2.

The following abbreviations are used in the tables below: GHC—guanidinehydrochloride, GC—guanidine chloride, HMD—hexamethylendiamine, OMD—octamethylenediamine, DDD—dioxadodecane-1,12-diamine, TODD—4,7,10-trioxitridecane-1,13-diamine, Tₕ—heating temperature, tₐ—aging time at certain temperature, t_{synth}—total synthesis time, Cᵣₑₛ—residual monomer concentration, MIC—minimum inhibiting concentration, MBC—minimum bactericide concentration.

TABLE 1

| | | | | | | heating during polycondensation | | | | | |
|---|---|---|---|---|---|---|---|---|---|---|---|
| | reaction mixture | | | Organic acid | | 1^{st} step | | 2^{nd} step | | 3^{d} step | |
| | guanidine | diamine | ratio | | % | Tₕ | tₐ | Tₕ | Tₐ | Tₕ | Tₐ |
| Ex. # | salt (G) | (D) | G:D | acid | w-ht | ° C. | h. | ° C. | h. | ° C. | h. |

PROPOSED

| | | | | | | | | | | | |
|---|---|---|---|---|---|---|---|---|---|---|---|
| 1 | GHC | HMD | 1:1 | citric | 0.23 | 120-130 | 1 | 150-160 | 3.5 | 180 | 1.5 |
| 2 | GHC | OMD | 1:1 | salicylic | 0.21 | 120-130 | 1 | 150-160 | 3.5 | 180 | 1.5 |
| 3 | GHC | DDD | 1:1 | palmic | 0.27 | 120-130 | 1 | 150-160 | 4 | 180 | 1.5 |
| 4 | GC | HMD, | 1:0.75:0.25 | oleic | 0.19 | 120-130 | 1 | 150-160 | 4 | 180 | 1 |
| | | TODD | | | | | | | | | |
| 5 | GHC | HMD | 1:1 | oxalic | 0.,1 | 120-130 | 1 | 150-160 | 3.5 | 180 | 1 |
| 6 | GHC | HMD | 1:1 | aspartic | 0.5 | 120-130 | 1 | 150-160 | 3.5 | 180 | 1 |
| 7 | GHC | HMD | 1:1 | vinic | 0.34 | 120-130 | 1 | 150-160 | 3.5 | 180 | 1.5 |
| 8 | GHC | HMD | 1:1 | maleic | 0.9 | 120-130 | 1 | 150-160 | 3.5 | 180 | 1.5 |
| 9 | GHC | HMD | 1:1 | isophthalic | 0.7 | 120-130 | 1 | 150-160 | 3.5 | 180 | 1.5 |
| 10 | GHC | HMD | 1:1 | citric | 0.01 | 125 | 1 | 155 | 3.5 | 170-180 | 1.5 |
| 11 | GHC | HMD | 1:1 | citric | 0.05 | 125 | 1 | 155 | 3.5 | 170-180 | 1.5 |
| 12 | GHC | HMD | 1:1 | citric, | 1.0 | 125 | 1 | 155 | 3.5 | 170-180 | 1.5 |
| | | | | maleic | | | | | | | |
| 13 | GHC | HMD | 1:1 | citric | 11.33 | 125 | 1 | 155 | 3.5 | 170-180 | 1.5 |
| 14 | GHC | HMD | 1:1 | citric | 16 | 125 | 1 | 155 | 3.5 | 170-180 | 1.5 |

PRIOR ART

| | | | | | | | | | | |
|---|---|---|---|---|---|---|---|---|---|---|
| GHC | HMD | 1:1 | — | — | 180 | 3 | 240 | 5 | — | — |

TABLE 2

| | | | | biological activity, test-culture | | | |
|---|---|---|---|---|---|---|---|
| | | | | Staf. Aureus | | Candida Albicans | |
| | | | | MIC, | MBC, | MIC, | MBC, |
| Ex. | t_{synth}, | Cᵣₑₛ, | viscosity, | mg/l × | mg/l × | mg/l × | mg/l × |
| # | h. | % w-ht | dl/g | 10⁻² | 10⁻² | 10⁻² | 10⁻² |
| 1 | 6 | 0.19 | 0.14 | 0.19 | 0.38 | 0.38 | 0.38 |
| 2 | 6 | 0.07 | 0.12 | 0.38 | 3.12 | 0.095 | 0.38 |
| 3 | 6.5 | 0.26 | 0.13 | 1.55 | 1.55 | 0.19 | 0.19 |
| 4 | 6 | 0.3 | 0.09 | 0.77 | 3.12 | 0.19 | 0.19 |
| 5 | 5.5 | 0.16 | 0.08 | 1.55 | 0.38 | 0.095 | 0.19 |
| 6 | 5.5 | 0.26 | 0.11 | 0.19 | 1.55 | 0.77 | 1.55 |
| 7 | 6 | 0.17 | 0.09 | 3.12 | 1.55 | 0.19 | 0.38 |
| 8 | 6 | 0.24 | 0.1 | 0.048 | 0.095 | 0.095 | 0.19 |
| 9 | 6 | 0.21 | 0.07 | 0.38 | 0.38 | 0.19 | 0.38 |
| 10 | 6 | 0.15 | 0.09 | 0.38 | 0.77 | 0.38 | 0.38 |
| 11 | 6 | 0.11 | 0.11 | 0.38 | 0.38 | 0.095 | 0.19 |
| 12 | 6 | 0.05 | 0.15 | 0.38 | 0.38 | 0.095 | 0.19 |
| 13 | 6 | 0.3 | 0.08 | 0.38 | 0.38 | 0.19 | 0.38 |
| 14 | 6 | 0.06 | 0.09 | 0.048 | 0.095 | 0.095 | 0.77 |
| prior | 8 | 3.0 | 0.07 | 3.12 | 6.24 | 1.55 | 3.12 |
| art | | | | | | | |

All obtained polyguanidines are high molecular compounds, having the appearance of transparent glasslike colorless or yellow-green substance, and viscosity within 0.07-0.15 dl/g, and residual monomer concentration within 0.05-0.3 weight %, and featuring a higher bioactivity and increased viscosity (Table 2). The total synthesis time shall not exceed 6.5 hours.

The features of the obtained polyguanidines allow them to be used for the purification of drinking and waste waters, the production of efficient non-toxic disinfectants, antiseptic agents and cosmetics.

While this invention has been particularly shown and described with references to preferred embodiments thereof, it will be understood by those skilled in the art that various changes in form and details may be made therein without departing from the scope of the invention encompassed by the appended claims.

What is claimed is:

1. A method for producing polyguanidine by polycondensating of a guanidine salt with diamine while heating, wherein polycondensation occurs in the presence of organic acid or a mixture of organic acids, and wherein the heating occurs step-wise in the regime of a gradual increase of temperature and holding a reaction mixture in at a defined temperature for a defined time.

2. The method as claimed in claim 1, wherein the gradual increase of temperature has a range of 120-130° C. for a first holding stage, 150-160° C. for a second holding stage; and 170-180° C. for third holding stage, and wherein the defined time is characterized by intervals 0.5-1 hour for the first holding stage, 3.5-4 hours for the second holding stage, 1-1.5 hour for the third holding stage.

3. The method as claimed in claim 1, wherein the diamine is an alkylenediamine or oxyalkylendiamine of general formula (I)
NH₂—R₁—NH₂, (1)
where R₁ is selected from:
C₂-C₁₀alkyl, —(CH₂)ₚ—O—(CH₂)_{q}—O—(CH)ᵣ, —(CH₂)ₚ—O—(CH₂)_{q}—O—(CH)ᵣ—O—(CH)₅, where p, q, q are selected from 2 to 6, or mixtures thereof.

4. The method as claimed in claim 3, wherein the diamine is hexamethylenediamine, octamethylenediamine, dioxadodecane-1,12-diamine, trioxamidecane-1,13-diamine, 3,6-diamine-1,8-diaminooctane.

5. The method as claimed in claim 1, wherein the guanidine salt is selected from the group consisted of guanidine chloride, guanidine sulphate, guanidine carbonate or guanidine nitrate.

6. The method as claimed in claim 1, wherein the acids are selected from the series:
monocarboxylic acids of the general formula:
R₁—COOH, (II)
where R₁ is selected from —C₉-C₁₈alkyl, —C₉-C₁₈alkenyl, —C₆H₅, —C₅H₄N, —C₅H₄CH₃, —C₅H₄NH₂, —C₅H₄OH, —C₅H₄OCOCH₂, or
dicarboxylic acids of the general formula:
HOOC—R₂—COOH, (III)
where R₂ is selected from —(CH₂)ₙ, n=0-8, —CₙH₂ₙ₋₁NH₂, n=1-4, —(CHOH)ₙ, n=1-4, —(CₙH₂ₙ₋₂), n=2-6, —C₆H₅, or
tricarboxylic acids of general formula:
R₃(COOH)₃, (IV)
where R₃ is selected from —CₙH₂ₙ₋₁₋ₘ(OH)ₘ, n=3-5, m=0-1,
or mixture thereof;

7. The method as claimed in claim 6, wherein the monocarboxylic acids are selected from the group consisted of, wherein decane acid, methanedecane acid, ethanedecane acid, propanedecane acid, butanedecane acid, pentanedecane acid, hexanedecane acid, heptanedecane acid, octanedecane acid, nonanedecane acid, decene acid, methanedecen acid, ethanedecen acid, propanedecen acid, butanedecen acid, pentanedecen acid, hexanedecen acid, heptanedecen acid, octanedecen acid, nonanedecen acid, benzoic acid, (ortho-, meta-, para-)toluoylic acid, (ortho-, meta-, para-)aminebenzoic acid, (ortho-, meta-, para-)hydroxybenzoic acid, (ortho-, meta-, para-)acetylhydroxibenzoic acid, pyridincarboxylic acid or mixtures thereof.

8. The method as claimed in claim 6, wherein the dicarboxylic acids are selected from the group consisted of ethane diacid, propane diacid, butane diacid, pentane diacid, hexane diacid, heptane diacid, octane diacid, nonane diacid, decane diacid, α-aminopropane diacid, α-aminobutane diacid, α-aminopentane diacid, α-aminohexane diacid, α-aminopropane diacid, α-aminobutane diacid, α-aminopentane diacid, α-aminohexane diacid, α,β-dioxybutane diacid, α,β,γ-trioxypentane diacid, α,β,γ,ω-tetraoxyhexane diacid, butene diacid, pentene diacid, hexen diacid, heptene diacid, octene diacid, 1,2-benzene dicarboxylic, 1,3-benzene dicarboxylic, 1,4-benzene dicarboxylic acid or mixture thereof.

9. The method as claimed in claim 6, wherein the tricarboxylic acids are selected from the group consisted 2-oxy-1,2,3-propanetricarboxylic acid, 3-oxy-1,3,5-pentanetricarboxylic acid or mixture thereof.

10. The method as claimed in claim 1, wherein the guanidine salt and the diamine are taken in a 1:1 in molar proportion.

11. The method as claimed in claim 1, wherein the organic acid or the mixture of the organic acids are added in the amount of 0.01-16 weight % of the reaction mixture, preferably 0.05-1.0 weight % of the reaction mixture.

12. The method as claimed in claim 1, wherein the organic acid or the mixture of the organic acids are added in the amount of 0.05-1.0 weight % of the reaction mixture.

13. The method as claimed in claim 1, wherein the organic acid or the mixture of the organic acids are added before the heating and/or during the first stage of heating.
